(19) United States
(12) Patent Application Publication
(10) Pub. No.: US 2021/0065270 A1
(43) Pub. Date: Mar. 4, 2021

(54) AUTOMATIC DESIGN SYSTEM FOR CUSTOMIZED PRODUCT AND CLOUD-BASED DESIGN SYSTEM USING AUTOMATIC DESIGN SYSTEM

(71) Applicant: National Kaohsiung University of Science and Technology, Kaohsiung City (TW)

(72) Inventors: CHUN-CHIH KUO, Kaohsiung City (TW); CHIA-HUNG CHANG, Kaohsiung City (TW)

(21) Appl. No.: 17/003,072

(22) Filed: Aug. 26, 2020

(30) Foreign Application Priority Data
Aug. 27, 2019 (TW) 108130649

(51) Int. Cl. G06Q 30/06; G06Q 50/04; G06Q 10/08; G06F 30/10

(52) U.S. Cl. CPC G06Q 30/0621; G06Q 50/04; G06F 2111/02; G06Q 30/0637; G06F 30/10; G06Q 10/0875

(57) ABSTRACT

An automatic design system for a customized product includes: a client processing module, a product design specification call module, a vendor processing module, and a computing module, where the client processing module reads demand specification information of a customized product, output a 3D physical design drawing, output a quotation, and read a confirmation order; the product design specification call module inputs a product design specification database; the vendor processing module outputs actual specification information of the customized product and manufacturing and processing information of the customized product to a vendor; and the computing module calls the product design specification database according to the demand specification information of the customized product to determine the actual specification information of the customized product, and generate the manufacturing and processing information of the customized product according to the actual specification information of the customized product.

### BACKGROUND

### Technical Field

The present invention relates to an automatic design system for a customized product and a cloud-based design system using the automatic design system, and in particular, to a system that can automatically generate manufacturing and processing information of a customized product according to actual specification information of the customized product.

### Related Art

In a design phase of a customized product, intensive communication with customers is required, and sometimes it is even necessary to output a three-dimensional drawing of the product by using a CAD system or directly output a prototype by using a rapid prototyping machine to the customers for confirmation before a specification is determined. Therefore, it takes a considerable amount of manpower and time for production. If different customers have different design requirements or discussion ways, the entire design, customer confirmation, and automatic production are in chaos and slow progress. Taking an “electrical control box” product as an example, no matter in industrial wiring, factory wiring or processing mother machine, the electrical control box is always viewed. The electrical control box is mainly used to centrally arrange wires and control elements in the box, so that effects of centralized wiring management and beautiful appearance can be achieved in addition to protecting the control elements away from objects that cause harm such as a human body or moisture. In addition, a size, parts, a box opening, a box material, painting, and the like change according to customers' demands in the design of the electrical control box, and these client demands often cause many problems for manufacturers of the electrical control box. When more and more customers have different demands, coordination between company's business and the customers and box designing and manufacturing by design engineers are lengthy. As a result, when production scheduling fails to keep up with the customers' demands, the company suffers losses.

### SUMMARY

An objective of the present invention is to call a product design specification database according to demand specification information of a customized product to determine actual specification information of the customized product and generate manufacturing and processing information of the customized product according to the actual specification information of the customized product, so as to solve the existing problem of a product manufacturer that production efficiency and management of the entire factory are affected due to customized product orders of clients. Another objective of the present invention is to provide a cloud-based design system built on a cloud architecture.

In order to achieve the objective of the above automatic design system for a customized product, the present invention provides an automatic design system for a customized product. The automatic design system for a customized product is electrically coupled to a client, a vendor, and a product design specification database, respectively, and includes: a client processing module electrically coupled to the client and configured to read demand specification information of a customized product, output a 3D physical design drawing, output a quotation, and read a confirmation order; a product design specification call module electrically coupled to the product design specification database and configured to input the product design specification database; a vendor processing module electrically coupled to the vendor and configured to output actual specification information of the customized product and manufacturing and processing information of the customized product to the vendor; and a computing module configured to call the product design specification database according to the demand specification information of the customized product to determine the actual specification information of the customized product, and generate the manufacturing and processing information of the customized product according to the actual specification information of the customized product.

In an implementation, the generating the manufacturing and processing information of the customized product according to the actual specification information of the customized product is implemented by using a secondary programming development module of a computer-aided design system (CAD-Secondary-Development).

In an implementation, the product design specification database includes a product specification, a parts library, a product design database, and a knowledge base.

In an implementation, the manufacturing and processing information of the customized product includes a 3D physical design drawing, a 2D expansion drawing, and a parts list (BOM) table.

In an implementation, the secondary development module of the computer-aided design system is to provide an application programming interface (API) in a software development kit (SDK) for development work by using a function of the SDK.

In an implementation, the computer-aided design software adopts commercial computer-aided design software.

In an implementation, the commercial computer-aided design software is controlled by using a python programming language, the python programming language being converted into a Windows COM object format through a pywin32 extension element of the python programming language, and then an API of the computer-aided design software is connected to control a drawing operation of the computer-aided design software.

In order to achieve the objective of the above cloud-based design system, the present invention provides a cloud-based design system, including: the above automatic design system for a customized product; and a cloud-based design platform electrically coupled to the client processing module and the vendor processing module, respectively, where the cloud-based design platform is a web application platform, and the client processing module of the automatic design system for a customized product accepts, through the cloud-based design platform, design and input of the demand specification information of the customized product by the client, and provides the 3D physical design drawing and the quotation for the client to confirm and order reply information confirmed by the client.

In an implementation, the cloud-based design platform is developed by using a Django web framework.

In an implementation, the client includes a factory manufacturing management system configured to receive the order reply information of the cloud-based design platform and the manufacturing and processing information of the customized product, and perform product manufacturing and shipping processes accordingly.

A feature of the present invention is that the present invention can greatly reduce the time spent in business and design and avoid manpower and cost losses of invalid order input. The present invention innovatively develops a “cloud-based design system for a customized electrical control box product” including a cloud-based design platform and a product automation design system, and the electrical control box is designed for customers in the cloud-based design platform according to demands. After the design is completed, the cloud-based design platform send the demands to the product automation design system for design, and then the demands are returned to the cloud-based design system for the customers to read and confirm online and place orders. After the customers confirm the orders, the cloud-based design platform can directly send box drawings and parts list designed by the product automation design system to company's processing departments for manufacturing, and the customers can track a progress and a status of current orders on the cloud-based design platform. Finally, a virtual and real integration system of “local customers, local production and shipment” and “factories without borders” is achieved.

### BRIEF DESCRIPTION OF THE DRAWINGS

FIG. 1 is a system block diagram of an automatic design system for a customized product according to the present invention.

FIG. 2 is a system block diagram of a cloud-based design system according to the present invention.

FIG. 3 is a schematic diagram of communication between Python and Windows COM according to the present invention.

### DETAILED DESCRIPTION

Embodiments of the present invention are described in detail below with reference to the accompanying drawings, the accompanying drawings are mainly simplified schematic diagrams, and only exemplify the basic structure of the present invention schematically. Therefore, only the components related to the present invention are shown in the drawings, and are not drawn according to the quantity, shape, and size of the components during actual implementation. During actual implementation, the type, quantity, and proportion of the components may be changed, and the layout of the components may be more complicated.

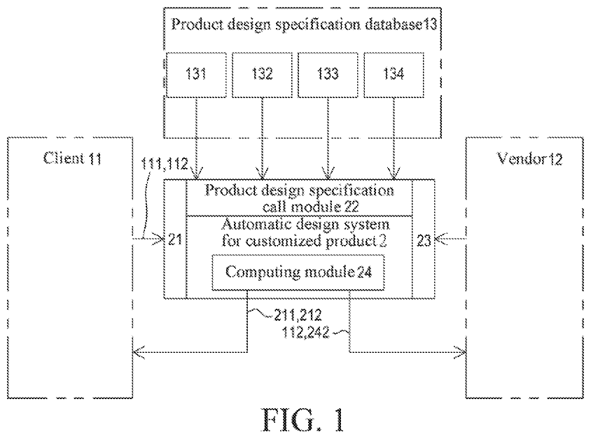

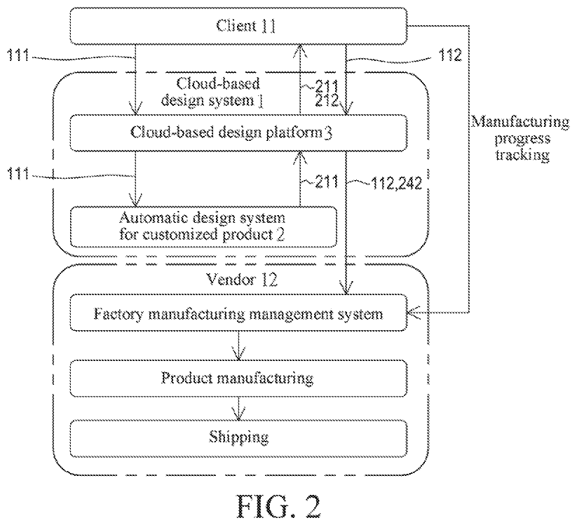

First, refer to FIG. 1 and FIG. 2. An automatic design system 2 for a customized product in this embodiment is electrically coupled to a client 11, a vendor 12, and a product design specification database 13, respectively, and includes: a client processing module 21 electrically coupled to the client 11 and configured to read demand specification information 111 of a customized product, output a 3D physical design drawing 211, output a quotation 212, and read a confirmation order 112; a product design specification call module 22 electrically coupled to the product design specification database 13 and configured to input the product design specification database 13; a vendor processing module 23 electrically coupled to the vendor 12 and configured to output actual specification information 241 of the customized product and manufacturing and processing information 242 of the customized product to the vendor 12; and a computing module 24 configured to call the product design specification database 13 according to the demand specification information 111 of the customized product to determine the actual specification information 241 of the customized product, and generate the manufacturing and processing information 242 of the customized product according to the actual specification information 241 of the customized product by using a secondary programming development module (CAD-Secondary-Development) of a computer-aided design system (such as commercial computer-aided design software supporting a python programming language).

The secondary development module of the computer-aided design system is to provide an application programming interface (API) in a software development kit (SDK) for development work by using a function of the SDK.

As shown in FIG. 1, in an embodiment, the product design specification database 13 includes a product specification 131, a parts library 132, a product design database 133, and a knowledge base 134.

In an embodiment, the manufacturing and processing information of the customized product includes a 3D physical design drawing, a 2D expansion drawing, and a parts list (BOM) table.

In an embodiment, the secondary development module of the computer-aided design system uses a function of an SDK to provide an API in the SDK for development work.

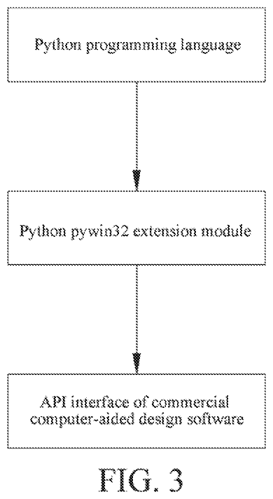

Refer to FIG. 3. In an embodiment, the commercial computer-aided design software is controlled by using a python programming language, the python programming language being converted into a Windows COM object format through a pywin32 extension element of the python programming language, and then an API of the computer-aided design software is connected to control a drawing operation of the computer-aided design software.

Refer to FIG. 2 again. A cloud-based design system 1 in this embodiment includes: the above automatic design system 2 for a customized product, and a cloud-based design platform 3 electrically coupled to the client processing module 21 and the vendor processing module 23, respectively, where the cloud-based design platform 3 is a web application platform, and the client processing module 21 of the automatic design system 2 for a customized product accepts, through the cloud-based design platform 3, design and input of the demand specification information 111 of the customized product by the client 11, and provides the 3D physical design drawing 211 and the quotation 212 for the client 11 for confirmation and order reply information confirmed by the client 11, namely, the confirmation order 112.

In an embodiment of the present invention, the cloud-based design platform is developed by using a Django web framework.

In an embodiment of the present invention, the client includes a factory manufacturing management system configured to receive the order reply information of the cloud-based design platform and the manufacturing and processing information of the customized product, and perform product manufacturing and shipping processes accordingly.

For example, in the case of the above customized product of the box, after a customer of the client 11 puts forward a box specification and a demand through the cloud-based design platform 3 (the demand specification information 111 of the customized product), the customized product automatic design system 2 automatically completes a 3D physical design of the box, and actively notify the customer through the cloud-based design platform 3 to browse a 3D box diagram and quotation information online. In addition, a 2D box expansion drawing and a parts list (BOM) are stored in the platform system. When the customer places an order after completing the drawing review and confirmation, the cloud-based design platform sends the 2D box expansion drawing and the parts list (BOM) stored on the platform to a factory manufacturing system for production, and the customer can track an order progress on the cloud-based design platform. An ultimate objective of the present invention is as follows: A cloud design service for an electrical control box product is provided, and after the customer completes design demand review and places an order, the system forwards the order to the factory manufacturing system of the customer for manufacturing. After the manufacturing is completed, the product is delivered locally to the customer, thereby achieving a platform as a service (PaaS) model in cloud-based design and manufacturing (CBDM).

The above embodiments merely exemplify the principles, features, and effects of the present invention, but are not intended to limit the implementation scope of the present invention. A person skilled in the art can modify or change the above embodiments without departing from the spirit and scope of the present invention. Any equivalent change or modification made using the contents disclosed by the present invention shall remain within the scope of the claims below. Therefore, the protection scope of the present invention should be as specified in the scope of the claims.

What is claimed is:

1. An automatic design system for a customized product, the automatic design system for a customized product being electrically coupled to a client, a vendor, and a product design specification database, respectively, and comprising:
a client processing module electrically coupled to the client and configured to read demand specification information of a customized product, output a 3D physical design drawing, output a quotation, and read a confirmation order;
a product design specification call module electrically coupled to the product design specification database and configured to input the product design specification database;
a vendor processing module electrically coupled to the vendor and configured to output actual specification information of the customized product and manufacturing and processing information of the customized product to the vendor; and
a computing module configured to call the product design specification database according to the demand specification information of the customized product to determine the actual specification information of the customized product, and generate the manufacturing and processing information of the customized product according to the actual specification information of the customized product by using a secondary programming development module of a computer-aided design system.

2. The automatic design system for a customized product according to claim 1, wherein the product design specification database comprises a product specification, a parts library, a product design database, and a knowledge base.

3. The automatic design system for a customized product according to claim 1, wherein the manufacturing and processing information of the customized product comprises a 3D physical design drawing, a 2D expansion drawing, and a parts list (BOM) table.

4. The automatic design system for a customized product according to claim 1, wherein the secondary development module of the computer-aided design system is to provide an application programming interface (API) in a software development kit (SDK) for development work by using a function of the SDK.

5. The automatic design system for a customized product according to claim 4, wherein the computer-aided design system adopts commercial computer-aided design software.

6. The automatic design system for a customized product according to claim 5, wherein the commercial computer-aided design software is controlled by using a python programming language, the python programming language being converted into a Windows COM object format through a pywin32 extension element of the python programming language, and then an API of the computer-aided design software is connected to control a drawing operation of the computer-aided design software.

7. A cloud-based design system, comprising:
the automatic design system for a customized product according to any of claims 1 to 7; and
a cloud-based design platform electrically coupled to the client processing module and the vendor processing module, respectively, wherein the cloud-based design platform is a web application platform, and the client processing module of the automatic design system for a customized product accepts, through the cloud-based design platform, design and input of the demand specification information of the customized product by the client, and provides the 3D physical design drawing and the quotation for the client to confirm and the confirmation order confirmed by the client.

8. The cloud-based design system according to claim 7, wherein the cloud-based design platform is developed by using a Django web framework.

9. The cloud-based design system according to claim 8, wherein the client comprises a factory manufacturing management system configured to receive order reply information of the cloud-based design platform and the manufacturing and processing information of the customized product, and perform product manufacturing and shipping processes accordingly.
